(19) United States
(12) Patent Application Publication
(10) Pub. No.: US 2010/0188438 A1
(43) Pub. Date: Jul. 29, 2010

(54) Backlight and Liquid Crystal Display Device

(75) Inventor: Jin Goo Kang, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(73) Assignee: LG INNOTEK CO., LTD., Seoul (KR)

(21) Appl. No.: 12/669,718

(22) PCT Filed: Jul. 17, 2008
(86) PCT No.: PCT/KR2008/004186

§ 371 Date: Jan. 19, 2010

(30) Foreign Application Priority Data
Jul. 20, 2007 (KR) 10-2007-0072704

(51) Int. Cl. G09G 5/10

(52) U.S. Cl. 345/690; 345/102

(57) ABSTRACT

A backlight and a liquid crystal display device are disclosed. The backlight comprises a plurality of light sources generating light, a selective signal output terminal through which selective signals for driving the light source are output, a multiplexer for multiplexing the selective signals to output driving signals for driving the respective light sources, and a current source for controlling a supply of power of the light sources using the driving signals. The liquid crystal display device comprises the backlight, a liquid crystal panel, and a system.

### TECHNICAL FIELD

The present disclosure relates to a backlight and a liquid crystal display (LCD) device.

### BACKGROUND ART

As an information processing technology develops, a variety of display devices such as LCD devices, plasma display panels (PDPs), and active matrix organic light emitting diodes (AMOLEDs) have been used. Particularly, the LCD device has a liquid crystal panel that displays an image by controlling a twisting angle of liquid crystal molecules of a plurality of liquid crystal cells that are arranged in a matrix pattern. In addition, the LCD device includes a backlight unit that emits light toward the liquid crystal panel so as to display the image.

### DISCLOSURE OF INVENTION

### Technical Problem

Embodiments provide a backlight that is designed to efficiently control a light source, increase power efficiency, and be formed in a simple structure.

### Technical Solution

In an embodiment, a backlight comprises: a plurality of light sources generating light; a selective signal output terminal through which selective signals for driving the light source are output; a multiplexer for multiplexing the selective signals to output driving signals for driving the respective light sources; and a current source for controlling a supply of power of the light sources using the driving signals.

In an embodiment, a liquid crystal display device comprises: a backlight comprising a multiplexer multiplexing selective signals to output driving signals, wherein the backlight generates lights having different colors by the driving signal; a liquid crystal panel displaying an image using the lights; and a system for generating signals for controlling the backlight and the liquid crystal panel.

In an embodiment, a liquid crystal display device comprises: a backlight comprising a plurality of light sources generating light, a selective signal output terminal through which selective signals for driving the light source are output, a multiplexer for multiplexing the selective signals to output driving signals for driving the respective light sources, and a current source for controlling a supply of power of the light sources using the driving signals; a liquid crystal panel for displaying an image using the light; and a driving chip disposed at a side of the liquid crystal panel to drive the liquid crystal panel.

### ADVANTAGEOUS EFFECTS

The backlight of the embodiment includes the multiplexer for multiplexing the selective signals to output driving signals for driving the respective light sources. That is, the multiplexer multiplexes the selective signals to output more driving signals than the selective signals.

Therefore, the backlight light can emit light using the selective signals the number of which is less than the light sources. Therefore, the backlight light can generate the driving signals using the simpler structure.

In addition, since the backlight controls the light sources using a relative small number of the selective signals, the light sources can be more efficiently controlled.

Further, the backlight of the embodiment can sequentially generate lights having different colors. Therefore, the backlight can display an image by combining the liquid crystal panel using the lights.

Therefore, since the backlight according to the embodiment does not simultaneously drive all of the light sources but sequentially drive the light sources, the backlight can be driven with low power.

Further, the liquid crystal display device in accordance with the embodiment includes the liquid crystal panel for displaying the image and the driving chip for driving the liquid crystal panel.

At this point, since the light sources and the liquid crystal panel can be simultaneously driven by the selective signals generated by the driving chip, the backlight and the liquid crystal panel can be efficiently controlled.

Further, the embodiment can provide a FSC mode liquid crystal display device that displays an image using red, green, and blue colors that are sequentially emitted, does not use color filter, and can be efficiently driven.

### BRIEF DESCRIPTION OF THE DRAWINGS

FIG. 1 is an exploded perspective view of a liquid crystal display device according to an embodiment.

FIG. 2 is a block diagram of the liquid crystal display device according to an embodiment.

FIG. 3 is a circuit diagram of a multiplexer according to an embodiment.

FIG. 4 is a circuit diagram of a current source.

FIG. 5 is a block diagram of a liquid crystal display device according to another embodiment.

FIG. 6 is a block diagram of a liquid crystal display device according to another embodiment.

FIG. 7 is a block diagram illustrating a driver integrated circuit (IC) of FIG. 6.

### BEST MODE FOR CARRYING OUT THE INVENTION

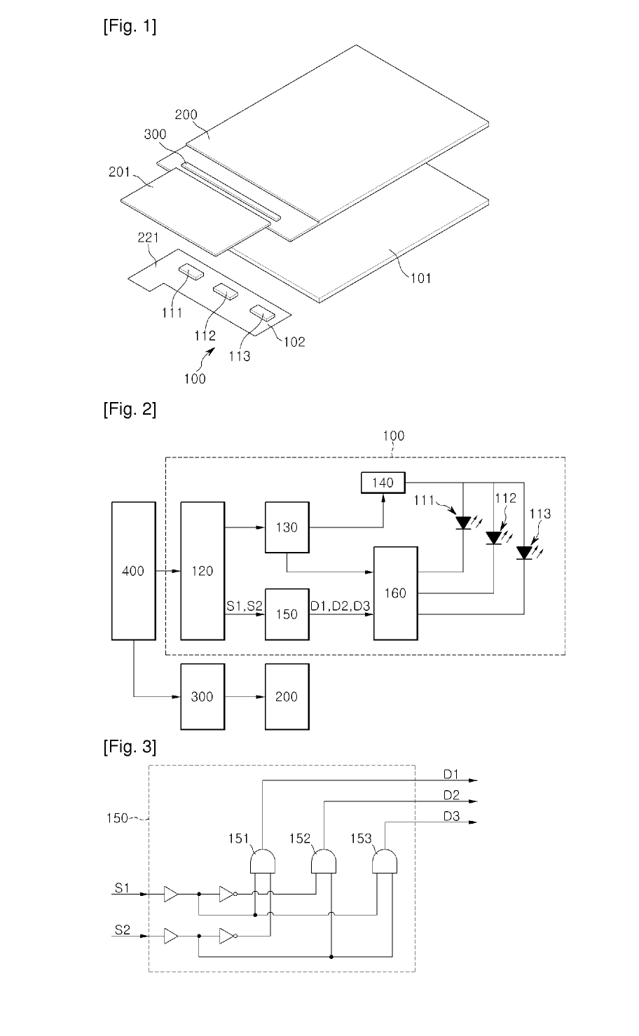

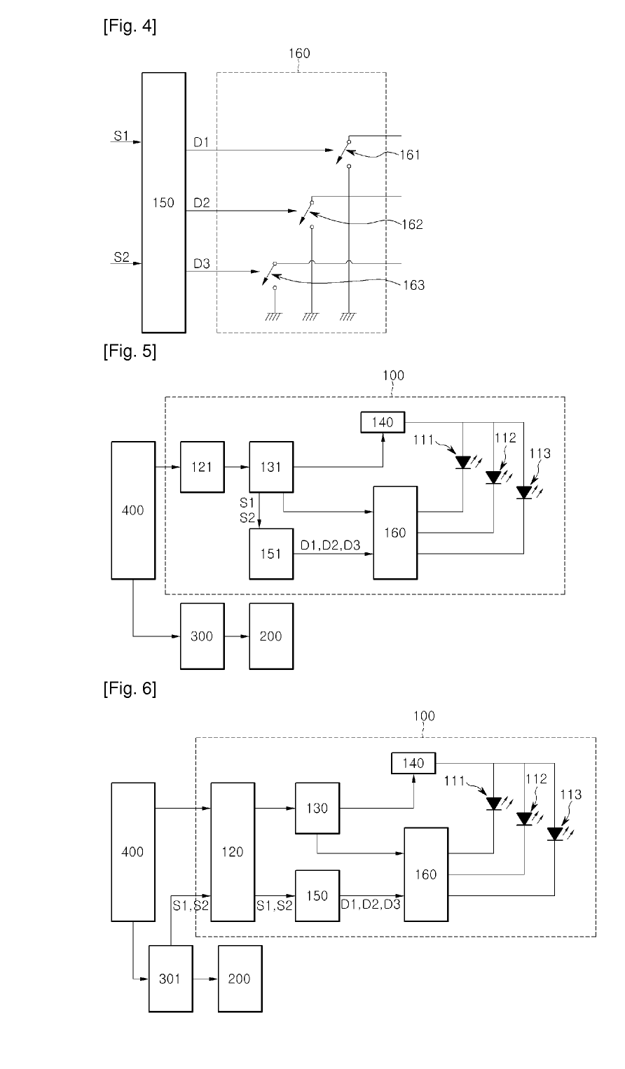

FIG. 1 is an exploded perspective view of a liquid crystal display device according to an embodiment, FIG. 2 is a block diagram of the liquid crystal display device according to an embodiment, and FIG. 3 is a circuit diagram of a multiplexer according to an embodiment. FIG. 4 is circuit diagram of a current source.

Referring to FIGS. 1 and 2, a liquid crystal display device includes a backlight 100, a liquid crystal panel 200, a driver IC 300, and a system 400.

The backlight 100 generates and emits light toward the liquid crystal panel 200. In more detail, the backlight 100 sequentially emits lights having different colors. That is, the backlight 100 sequentially and repeatedly emits red, green, and blue lights.

For example, the backlight emits the red light for several ms and subsequently emits the green light for several ms, after which the backlight emits the blue light for several ms. This is repeated to repeatedly emit the red, green, and blue lights.

The backlight 100 includes light emitting diodes 111, 112, and 113, an input/output interface 120, a controller 130, a direct current/direct current (DC/DC) converter 140, a multiplexer 150, and a current source 160.

The light emitting diodes 111, 112, and 113 generates light having different colors. The light emitting diode 111 will be referred to as a first light emitting diode generating the red light and the light emitting diode 112 will be referred to as a second diode generating the green light. In addition, the light emitting diode 113 will be referred to as a third light emitting diode generating the blue light.

The input/output interface 120 receives signals from an external side. In addition, the input/output interface 120 can output internal signals to the external side. In more detail, the input/output interface 120 receives backlight control signals for controlling the backlight 100 from the system 400.

The backlight control signals include selective signals S1 and S2 for driving the light emitting diodes 111, 112, and 113. The selective signals S1 and S2 are applied to the multiplexer 150 through a selective signal output terminal of the input/output interface 120. In addition, the backlight control signals are applied to the controller 130.

The controller 130 controls the DC/DC converter 140 and the current source 160 in response to the backlight control signals. For example, the controller 130 generates a signal for operating the DC/DC converter 140 and a signal for controlling luminance of the light emitting diodes 111, 112, and 113 and applies the generated signals respectively to the DC/DC converter 140 and the current source 160.

The DC/DC converter 140 converts an external power voltage into an internal driving voltage in accordance with the control of the controller 130. Further, the DC/DC converter 140 applies the driving voltage to the light emitting diodes 111, 112, and 113.

The light emitting diodes 111, 112, and 113 generates lights using the driving voltage. The light emitting diodes 111, 112, and 113 are connected to the DC/DC converter in parallel to receive the driving voltage. Unlike this, the light emitting diodes 111, 112, and 113 may be connected to the DC/DC converter 140 in series.

Referring to FIG. 3, the multiplexer 150 receives the selective signals S1 and S2 from the input/output interface 120 and multiplexes the same to generate driving signals D1, D2, and D3. In more detail, the multiplexer 150 receives the selective signals S1 and S2 through the selective signal output terminal of the input/output interface 120.

The selective signals S1 and S2 will be respectively referred to as first and second selective signals that are digital signals. The driving signals D1, D2, and D3 will be referred to as first, second, and third driving signals.

The multiplexer 150 includes a first AND logic element 151, a second AND logic element 152, and a third AND logic element 153.

The first AND logic element 151 generates the first driving signal D1 by performing AND operation on the first selective signal S1 and an inverse signal of the second selective signal S2.

The second AND logic element 152 generates the second driving signal D2 by performing AND operation on an inverse signal of the first selective signal S1 and the second selective signal S2.

The third AND logic element 153 generates the third driving signal D3 by performing AND operation on the first selective signal S1 and the second selective signal S2.

Referring to FIGS. 2 and 4, the current source 160 controls amounts of currents flowing along the light emitting diodes 111, 112, and 113 in accordance with the control of the controller 130 to adjust the luminance of each of the light emitting diodes 111, 112, and 113.

Further, the current source 160 controls On/Off of the light emitting diodes 111, 112, and 113 in accordance with the driving signals D1, D2, and D3. In more detail, the current source 160 is connected to the respective light emitting diodes 111, 112, and 113. The current source 160 includes switching elements 161, 162, and 163 controlled by the driving signals D1, D2, and D3.

The first switching element 161 connected to the first light emitting diode 111 is controlled by the first driving signal D1. That is, the first driving signal D1 operates the first switching element 161 to turn on or off the first light emitting diode 111.

The second switching element 162 connected to the second light emitting diode 112 is controlled by the second driving signal D2. That is, the second driving signal D2 operates the second switching element 162 to turn on or off the second light emitting diode 112.

The third switching element 163 connected to the third light emitting diode 113 is controlled by the third driving signal D3. That is, the third driving signal D3 operates the third switching element 163 to turn on or off the second light emitting diode 113.

That is, the first driving signal D1 determines if the red light is emitted from the backlight 100, the second driving signal D2 determines if the green light is emitted from the backlight 100, and the third driving signal D3 determines if the blue light is emitted from the backlight 100.

For example, when the first and second selective signals S1 and S2 are ‘00,’ the first, second, and third AND logic elements 151, 152, and 153 do not generate the respective first, second, and third driving signals D1, D2, and D3. Therefore, the light emitting diodes 111, 112, and 113 do not generate the lights.

In addition, when the first and second selective signals S1 and S2 are ‘10,’ only the first AND logic element 151 generates the first driving signal D1 and thus the first switching element 161 is turned on. Therefore, the first light emitting diode 111 generates the green light.

In addition, when the first and second selective signals S1 and S2 are ‘01,’ only the second AND logic element 152 generates the second driving signal D2 and thus the second switching element 162 is turned on. Therefore, the second light emitting diode 112 generates the red light.

In addition, when the first and second selective signals S1 and S2 are ‘11,’ only the third AND logic element 153 generates the third driving signal D3 and thus the third switching element 163 is turned on. Therefore, the third light emitting diode 113 generates the blue light.

The first and second selective signals S1 and S2 may be ‘00,’ ‘10,’ ‘01,’ and ‘11’ that are sequentially input. Accordingly, after the light emitting diodes 111, 112, and 113 are turned off, the first, second, and third light emitting diodes 111, 112, and 113 are sequentially turned on.

That is, when the system 40 inputs the selective signals S1 and S2 to the input/output interface 120 as shown in the following table 1, the backlight 100 operates as shown in the table 1. In addition, as the selective signals S1 and S2 are sequentially input to the input/output interface 120, the backlight sequentially operates as shown in the table 1. In addition, the input order of the selective signals S1 and S2 may be variously altered.

TABLE 1

| | | MULTIPLEXER | BACKLIGHT |
|---|---|---|---|
| S1 | S2 | OUTPUT | OPERATION |
| 0 | 0 | | |
| 1 | 0 | D1 | RED LIGHT |
| 0 | 1 | D2 | GREEN LIGHT |
| 1 | 1 | D3 | BLUE LIGHT |

Unlike the above, in accordance with a circuit structure of the multiplexer, all of the light emitting diodes 111, 112, and 113 may operate when the first and second selective signals S1 and S2 ‘00.’ In this case, the backlight 100 generates white light. In addition, when the first and second selective signals S1 and S2 are ‘10,’ ‘01,’ ‘11, ’ two of the light emitting diodes 111, 112, and 113 may operate.

The backlight 100 may further include a flexible printed circuit board 102 on which the light emitting diodes 111, 112, and 113 are mounted and a light guide plate 101 for guiding the light emitted from the light emitting diodes 111, 112, and 113.

The liquid crystal panel 200 displays an image using the light emitted from the backlight 100. The liquid crystal panel 200 adjusts intensity of the light emitted from the backlight 100 for respective pixels and transmits the light to display the image.

The liquid crystal panel 200 includes two substrates facing each other at a pre-determined interval and a liquid crystal layer interposed between the substrates. The liquid crystal panel 200 includes a plurality of gate lines extending in a first direction and a plurality of data lines extending in a second direction intersecting the first direction.

In addition, the liquid crystal panel 200 includes a plurality of thin film transistors that are located at intersection regions of the gate and data lines. The liquid crystal panel 200 further includes a pixel electrode receiving the data signals and a common electrode receiving common voltage in accordance with the operation of the thin film transistors.

The liquid crystal layer is aligned by an electric field formed between the pixel electrode and the common electrode and adjusts the intensity of the light for the respective pixels.

The driver IC 300 receives a control signal from the system 400 to drive the liquid crystal panel 200. For example, the driver IC 300 may be mounted on the crystal panel in the form of a driving chip.

The system 400 applies the control signals to the backlight 100 and the driver IC 300 to drive the backlight 100 and the liquid crystal panel 200. In more detail, the system 400 organically drives the backlight 100 and the liquid crystal panel 200.

For example, by the system 400, the backlight 100 emits the red light and the liquid crystal panel 200 adjusts a ratio of the red light for each pixel to display the image.

Likewise, by the system 400, the backlight 100 emits the green light and the liquid crystal panel 200 adjusts a ratio of the green light for each pixel to display the image.

Likewise, by the system 400, the backlight 100 emits the blue light and the liquid crystal panel 200 adjusts a ratio of the blue light for each pixel to display the image.

As described above, by the system 400, the backlight and the liquid crystal panel 200 can sequentially and quickly display the red, green, and blue images and the screen displays an image mixed with the red, green, and blue.

the system 400 is electrically connected to the driver IC 300 by the flexible printed circuit board 201 connected to the liquid crystal panel 200.

The backlight 100 of this embodiment includes the multiplexer 150 that multiplexes the selective signals S1 and S2 to output the driving signals D1, D2, and D3 for driving the light sources. That is, the multiplexer 150 multiplexes the selective signals S1 and S2 to output more driving signals D1, D2, and D3.

Therefore, the backlight 100 can generate the light using the selective signals S1 and S2, the number of which is less than the light emitting diodes 111, 112, and 113. That is, the back light 100 can generate the driving signals D1, D2, and D3, using a simple circuit.

Therefore, since the liquid crystal display device of the embodiment controls three light emitting diodes using two selective signals, the light emitting diodes 111, 112, and 113 can be more efficiently controlled.

Further, since the backlight 100 does not simultaneously operate all of the light sources but sequentially operates the light source, the liquid crystal display device of the embodiment can be driven by a relative lower power.

In addition, the embodiment can provide a field sequential color (FSC) mode liquid crystal display device that can be efficiently driven.

FIG. 5 is a block diagram of a liquid crystal display device according to another embodiment. A description of this embodiment will refer to the description of the foregoing embodiment and the input/output interface and controller will be further described.

Referring to FIG. 5, a system 400 inputs backlight control signals to an input/output interface 121 and the input/output interface 121 inputs the backlight control signals to a controller 131.

The controller 131 generates selective signals S1 and S2 using the backlight control signals. At this point, the controller 131 may generate the selective signals S1 and S2 by modulating a clock signal that is generated in accordance with an internal standard.

The selective signals S1 and S2 are applied to the multiplexer 151 through a selective signal output terminal of the controller 131.

The selective signals S1 and S2 are not applied from the system 400 but generated in the backlight 100. Therefore, the system 400 and the backlight 100 can be standardized and manufactured.

That is, the backlight 100 can emit lights having different colors at predetermined intervals regardless of the system coupled to the backlight 100. Therefore, the liquid crystal display device in accordance with this embodiment may be manufactured by a combination of a system and a backlight that are respectively manufactured by different manufacturers.

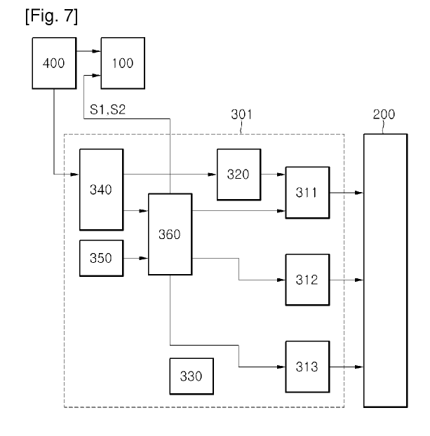

FIG. 6 is a block diagram of a liquid crystal display device according to another embodiment, and FIG. 7 is a block diagram illustrating a driver integrated circuit (IC) of FIG. 6. A description of this embodiment will refer to the description of the foregoing embodiments and the driver IC and system will be further described.

Referring to FIGS. 6 and 7, a system 400 inputs a control signal generating a selective signal to a driver IC 301.

The driver IC 301 generates a signal for driving a liquid crystal panel 200 and selective signals S1 and S2 for driving the backlight 100. The driver IC 300 includes drivers 311, 312, and 313, a display RAM 320, a power circuit 330, a register 340, an oscillator 350, and a timing controller 360.

The drivers 311, 312, and 313 are respectively a gate driver 311 for generating a gate signal applied to the liquid crystal panel 200, a data driver 312 for generating a data signal applied to the liquid crystal panel 200, and a common driver 313 for generating a common voltage applied to the liquid crystal panel 200.

The display RAM 320 stores and loads the data for displaying an image input from the system 400.

The power circuit 330 receives an external power voltage and converts the external power voltage into an internal power voltage. The power circuit 330 applies the driving voltage to the drivers 311, 312, and 313, the display RAM 320, the register 340, the oscillator 350, and the timing controller 360.

The register 340 receives a control signal for generating the selective signals S1 and S2 and a control signal for driving the liquid crystal panel 200 from the system 400 to control the timing controller 360. In addition, the register 340 inputs the data for displaying the image to the display RAM 320.

The oscillator 350 generates a clock signal having a predetermined frequency according to its internal standard and inputs the clock signal to the timing controller 360.

The timing controller 360 generates the selective signals S1 and S2 and timing signals for driving the drivers 311, 312, and 313 based on the clock signal in accordance with the control of the register 340.

The selective signals S1 and S2 are input to the backlight 100 through the input/output interface 120 to drive the light emitting diodes 111, 112, and 113.

The liquid crystal display device in accordance with this embodiment displays the image by driving the liquid crystal panel 200 and the backlight 100 using the driver IC 300. That is, the liquid crystal panel 200 and the backlight 100 may be driven by the timing controller 360.

Therefore, the liquid crystal display device in accordance with this embodiment can organically drive the liquid crystal panel 200 and the backlight 100. That is, the liquid crystal display device in accordance with this embodiment can efficiently adjust a color of the light emitted from the backlight 100 and an image defined by the light.

Particularly, the embodiment can provide a FSC mode liquid crystal display device that displays an image using red, green, and blue colors that are sequentially emitted and can be efficiently driven.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

The backlight and liquid crystal display device according to the embodiments can be applied to a display field.

1. A backlight comprising:
a plurality of light sources generating light;
a selective signal output terminal through which selective signals for driving the light source are output;
a multiplexer for multiplexing the selective signals to output driving signals for driving the respective light sources; and
a current source for controlling a supply of power of the light sources using the driving signals.

2. The backlight according to claim 1, wherein the light sources comprise first, second, and third light emitting diodes for generating lights having difference colors; and
the driving signals comprise a first driving signal for driving the first light emitting diode, a second driving signal for driving the second light emitting diode, and a third driving signal for driving the third light emitting diode.

3. The backlight according to claim 2, wherein the selective signals comprise first and second selective signals that are digital signals.

4. The backlight according to claim 3, wherein, when the first and second selective signals are ‘00,’ the first, second, and third light emitting diodes are turned off;
when the first and second selective signals are ‘10,’ the multiplexer outputs the first driving signal;
when the first and second selective signals are ‘01,’ the multiplexer outputs the second driving signal; and
when the first and second selective signals are ‘11,’ the multiplexer outputs the third driving signal.

5. The backlight according to claim 3, wherein, when the first and second selective signals are ‘10,’ the multiplexer outputs the first and second driving signals;
when the first and second selective signals are ‘01,’ the multiplexer outputs the second and third driving signals; and
when the first and second selective signals are ‘11,’ the multiplexer outputs the third and first driving signals.

6. The backlight according to claim 3, wherein, when the first and second selective signals are ‘00,’ the multiplexer simultaneously outputs the first, second, and third driving signals.

7. The backlight according to claim 3, wherein the multiplexer comprises:
a first AND logic element for generating the first driving signal by performing AND operation on the first selective signal and an inverse signal of the second selective signal;
a second AND logic element for generating the second driving signal by performing AND operation on an inverse signal of the first selective signal and the second selective signal; and
a third AND logic element for generating the third driving signal by performing AND operation on the first selective signal and the second selective signal.

8. The backlight according to claim 1, comprising a direct current/direct current converter that receives an external power voltage and coverts the external power voltage into an internal driving voltage to supply the driving voltage to the light sources.

9. The backlight according to claim 1, wherein the current source comprises switching elements that are respectively switched by the driving signals.

10. A liquid crystal display device comprising:
a backlight comprising a multiplexer multiplexing selective signals to output driving signals, wherein the backlight generates lights having different colors by the driving signal;
a liquid crystal panel displaying an image using the lights; and
a system for generating signals for controlling the backlight and the liquid crystal panel.

11. The liquid crystal display device according to claim 10, wherein the selective signals comprise first and second selective signals that are digital signals; and the multiplexer outputs a first driving signal for generating a light having a first color, a second driving signal for generating a light having a second color, and a third driving signal for generating a light having a third color.

12. The liquid crystal display device according to claim 10, wherein the system generates the selective signals and applies the selective signals to the backlight.

13. The liquid crystal display device according to claim 10, wherein the backlight generates red, green, and blue lights

14. A liquid crystal display device comprising:
a backlight comprising a plurality of light sources generating light, a selective signal output terminal through which selective signals for driving the light source are output, a multiplexer for multiplexing the selective signals to output driving signals for driving the respective light sources, and a current source for controlling a supply of power of the light sources using the driving signals;
a liquid crystal panel for displaying an image using the light; and
a driving chip disposed at a side of the liquid crystal panel to drive the liquid crystal panel.

15. The liquid crystal display device according to claim 14, wherein the selective signals are generated by the driving chip.

16. The liquid crystal display device according to claim 15, wherein the driving chip comprises:
a gate drover applying a gate signal to the liquid crystal panel;
a data driver applying a data signal to the liquid crystal panel; and
a timing controller applying timing signals to the gate and data drivers, wherein the timing controller generates the selective signals.

17. The liquid crystal display device according to claim 14, wherein the number of the selective signals is two and the number of the driving signals is three.

18. The liquid crystal display device according to claim 14, comprising a system for generating the selective signals, wherein the backlight comprises an input/output interface for receiving the selective signals from the system and the input/output interface outputs the selective signals through the selective signal output terminal.

19. The liquid crystal display device according to claim 14, wherein the backlight comprises:
a direct current/direct current converter that receives an external power voltage and coverts the external power voltage into an internal driving voltage to supply the driving voltage to the light sources; and
a controller for controlling the direct current/direct current converter and the current source.

20. The liquid crystal display device according to claim 19, wherein the controller generates the selective signals and outputs the selective signals through the selective signal output terminal.
